(19) United States
(12) Patent Application Publication
(10) Pub. No.: US 2019/0140906 A1
(43) Pub. Date: May 9, 2019

(54) DYNAMICALLY OPTIMIZING INTERNET OF THINGS DEVICE CONFIGURATION RULES VIA A GATEWAY

(71) Applicant: International Business Machines Corporation, Armonk, NY (US)

(72) Inventors: Sanehiro Furuichi, Setagaya-Ku (JP); Takahito Tashiro, Albany, CA (US)

(21) Appl. No.: 15/807,718

(22) Filed: Nov. 9, 2017

(51) Int. Cl. H04L 12/24; G06F 17/30; H04L 29/08

(52) U.S. Cl. CPC H04L 41/12; G06F 17/30283; H04L 12/66; H04L 67/12; H04L 41/0866

(57) ABSTRACT

Management and optimization of internet of things (IoT) device configuration rules is provided. A gateway node identifies usage-requests that describe one or more contract events. The gateway node identifies a plurality of IoT sensors with a local IoT environment. The gateway node identifies template rules that describe conditions for registering occurrences of the one or more contract events. The gateway node identifies the template rules that correspond to the types of IoT sensors in the local IoT environment. The gateway node constructs device configuration rules based on the template rules and properties of the IoT sensors within the local IoT environment to register the occurrence of contract events within the local IoT environment. The gateway node optimizes the device configuration rules based on how the conditions and the IoT sensor in the local IoT environment change over time to, for example, increase the accuracy of registering contract events.

### TECHNICAL FIELD

The present invention relates generally to the field of managing an Internet of Things (IoT) and, more particularly, to dynamically optimizing internet of things device configuration rules via a gateway.

### BACKGROUND

The IoT is a type of emerging network infrastructure that can benefit society. At a basic level, the IoT network integrates a distributed network of “things” into existing information technology infrastructure. In general, a “thing” in the IoT is an object embedded with sensors (i.e., an IoT sensory device) that generates data about an ambient environment so that the IoT sensory device can transmit that data to other nodes of an IoT network. Generally, IoT sensory devices are distributed over a relatively broad area. For example, IoT sensory devices can be distributed throughout a residential, commercial, or industrial structure to monitor various environmental factors and/or activities within such structures. In many applications of IoT technology, the IoT sensory devices have minimal onboard processing power to reduce their respective costs, form factors, and power requirements. Depending on the placement, the redundancy, and the specific type(s) of sensors that are incorporated into an IoT sensory device, an IoT sensory device can obtain electrical power via onboard batteries and/or the electrical grid and can communicate data to other nodes in the IoT network via various wireless and/or wired protocols. In many applications of IoT technology, IoT sensory devices rely on more computationally powerful nodes in the IoT network to, among other things, analyze the data generated by the distributed and relatively simple IoT sensory devices and to present the data, and any insights made with respect to the data, to IoT portal users.

### SUMMARY

According to one embodiment of the present invention, a method for managing internet of things (IoT) device configuration rules is provided. The method includes: identifying, via a gateway node within an IoT network, a usage-request that describes one or more contract events; identifying, via the gateway node, a plurality of IoT sensory devices within a local IoT environment in response to querying a database for IoT sensory devices within the local IoT environment; identifying, via the gateway node, a plurality of template rules in response to querying the database for template rules that describe conditions for registering occurrences of the one or more contract events, wherein each template rule represents a rule for a type of IoT sensory device; identifying, via the gateway node, a subset of template rules from among the plurality of template rules that correspond to types of IoT sensory devices represented by a subset of IoT sensory device of the plurality of IoT sensory devices within the local IoT environment; constructing, via the gateway node, a set of device configuration rules based, at least in part, on the subset of template rules and the subset of IoT sensory devices within the local IoT environment, wherein the set of device configuration rules describes logical operations for registering occurrences the one or more contract events described in the usage-request via the subset of IoT sensory devices within the local IoT environment; and configuring, via the gateway node, the subset of IoT sensory devices in accordance with the set of device configuration rules.

According to another embodiment of the present invention, a computer program product for managing internet of things (IoT) device configuration rules is provided. The computer program product comprises a computer readable storage medium and program instructions stored on the computer readable storage medium. The program instructions include: program instructions to identify, via a gateway node within an IoT network, a usage-request that describes one or more contract events; program instructions to identify, via the gateway node, a plurality of IoT sensory devices within a local IoT environment in response to querying a database for IoT sensory devices within the local IoT environment; program instructions to identify, via the gateway node, a plurality of template rules in response to querying the database for template rules that describe conditions for registering occurrences of the one or more contract events, wherein each template rule represents a rule for a type of IoT sensory device; program instructions to identify, via the gateway node, a subset of template rules from among the plurality of template rules that correspond to types of IoT sensory devices represented by a subset of IoT sensory device of the plurality of IoT sensory devices within the local IoT environment; program instructions to construct, via the gateway node, a set of device configuration rules based, at least in part, on the subset of template rules and the subset of IoT sensory devices within the local IoT environment, wherein the set of device configuration rules describes logical operations for registering occurrences the one or more contract events described in the usage-request via the subset of IoT sensory devices within the local IoT environment; and program instructions to configure, via the gateway node, the subset of IoT sensory devices in accordance with the set of device configuration rules.

According to another embodiment of the present invention, a computer system for managing internet of things (IoT) device configuration rules is provided. The computer system includes one or more computer processors, one or more computer readable storage media, and program instructions stored on the computer readable storage media for execution by at least one of the one or more processors. The program instructions include: program instructions to identify, via a gateway node within an IoT network, a usage-request that describes one or more contract events; program instructions to identify, via the gateway node, a plurality of IoT sensory devices within a local IoT environment in response to querying a database for IoT sensory devices within the local IoT environment; program instructions to identify, via the gateway node, a plurality of template rules in response to querying the database for template rules that describe conditions for registering occurrences of the one or more contract events, wherein each template rule represents a rule for a type of IoT sensory device; program instructions to identify, via the gateway node, a subset of template rules from among the plurality of template rules that correspond to types of IoT sensory devices represented by a subset of IoT sensory device of the plurality of IoT sensory devices within the local IoT environment; program instructions to construct, via the gateway node, a set of device configuration rules based, at least in part, on the subset of template rules and the subset of IoT sensory devices within the local IoT environment, wherein the set of device configuration rules describes logical operations for registering occurrences the one or more contract events described in the usage-request via the subset of IoT sensory devices within the local IoT environment; and program instructions to configure, via the gateway node, the subset of IoT sensory devices in accordance with the set of device configuration rules.

### BRIEF DESCRIPTION OF THE DRAWINGS

FIG. 1 is a functional block diagram illustrating a computing environment, in accordance with an embodiment of the present invention.

FIG. 2 is a functional block diagram illustrating a portion of the computing environment depicted in FIG. 1 in greater detail, in accordance with an embodiment of the present invention.

FIG. 3 is a flowchart depicting operations of the gateway depicted in FIGS. 1 and 2 for configuring a plurality of IoT sensors within a local IoT environment in response to receiving a usage-request from an IoT application, in accordance with an embodiment of the present disclosure.

FIG. 4 is a flowchart depicting operations of the gateway depicted in FIGS. 1 and 2 for registering contract events within a local IoT environment in response to receiving a usage-request from an IoT application, in accordance with an embodiment of the present disclosure.

FIG. 5 is a flowchart depicting operations of the gateway depicted in FIGS. 1 and 2 for optimizing IoT sensory device configuration rules, in accordance with an embodiment of the present disclosure.

FIG. 6 is a block diagram of components of a computing device executing operations for dynamically optimizing internet of things device configurations via a gateway, in accordance with an embodiment of the present invention.

### DETAILED DESCRIPTION

Embodiments of the present invention recognize that, in general, IoT networks are hierarchical, at least in the sense that IoT sensory devices represent a “lowest” hierarchical level within an IoT network and other nodes in the IoT network (e.g., IoT servers) represent higher hierarchical levels within the IoT network. Additionally, embodiments of the present invention recognize that large amounts of data can flow between IoT sensory devices and higher level nodes in an IoT network in the form of raw sensor data and control commands. Due, for example, to limited onboard processing power, IoT sensory devices generate large amounts of data, and without processing the data, propagate the raw data to a higher level node with greater data processing capabilities within a respective IoT network, such as an IoT server that can execute various IoT applications. In order to aggregate and interpret the raw data obtained from the IoT sensory devices, IoT servers require sufficient resources to store and analyze the data. Providing the necessary resources, however, generally increases the cost and complexity of the IoT servers. Furthermore, IoT servers require yet more resources (e.g., processing power and memory) to dynamically manage IoT sensory devices that are utilized by IoT applications executing on the IoT servers. Embodiments of the present invention also recognize that it is advantageous to dynamically manage IoT sensory devices based on changes in the environment and/or changes with respect to available IoT sensory devices.

Embodiments of the present invention provide a gateway node that sits between IoT sensory devices and IoT servers within a hierarchy of an IoT network and advantageously enables, among other things, the storage and analysis of data at a lower hierarchical level within the IoT network. In various embodiments, for example, a gateway node can include a router and/or a network-attached storage device. Aggregating and analyzing raw sensor data in the gateway can advantageously enable the application server to have less processing power and/or memory and persistent storage. Additionally, aggregating and analyzing data in the gateway can enable the gateway to dynamically configure and manage local IoT sensory devices to improve the functioning of the IoT system as conditions change within the local environment without increasing the application server's resource requirements.

Embodiments of the present invention also recognize that infringement of privacy can be a concern when raw data is propagated from IoT sensory devices to other nodes within an IoT network. If, for example, an IoT sensory device generates image(s) of a person, transmitting the image(s) to an IoT server for analysis may raise concerns with respect to the privacy of the imaged person and proper use of the image(s). Embodiments of present invention provide, as part of a “local” IoT environment, a gateway node that can ameliorate such concerns by aggregating and analyzing various kinds of raw sensory data and transmitting the result(s) of the analyses to higher level nodes instead of raw sensor data, the raw sensor data generally remaining within the local IoT environment (e.g., image data can remain on a gateway within the home of a monitored individual).

More specifically, embodiments of the present invention provide, as part of a local IoT environment (i.e., a local IoT network), a gateway that collects and stores unprocessed raw data received from IoT sensory devices generating data with respect to various conditions within a “monitored environment.” The gateway processes the data received from the IoT sensory devices and stores the data, at least temporarily. The gateway aggregates and processes data from the IoT sensory devices in order to analyze conditions within the monitored environment for the occurrence of a “contract event.” The contract event represents a request that a user of an IoT application be sent notification(s) in response to either queries about the contract event and/or when the contract event occurs. As described subsequently in greater detail, an application server and/or IoT application describe the contract event, and various parameter related thereto, to the gateway as part of a “usage-request.” The usage-request includes, among other things, “detection conditions” for the contract event. More generally, the “usage-request” represents a negotiation to determine if the gateway and the local IoT environment can provide the requested service within the monitored environment. The gateway determines which sensory devices and/or combination of sensory devices to detect the contract event based, at least in part, on the pre-programmed templates and rules. Additionally, the gateway can advantageously and dynamically reconfigure, manage, and optimize sensory device configuration rules based on conditions in the monitored environment, the conditions of the IoT sensory devices within the local IoT environment, and identities of IoT sensory devices that connect to and disconnect from the gateway with the local IoT environment over a period of time. As described herein, the gateway can aggregate and analyze data from IoT sensory devices and can transmit information relating to the occurrence or nonoccurrence of a contract event to the application server, but the gateway does not necessarily transmit any raw data from IoT sensory devices to the application server.

Embodiments of the present invention will now be described in detail with reference to the Figures. It is to be understood that these embodiments are described only for the purpose of illustration and help those skilled in the art to understand and implement the present invention, without suggesting any limitation as to the scope of the invention. The invention described herein can be implemented in various manners other than the ones explicitly described herein.

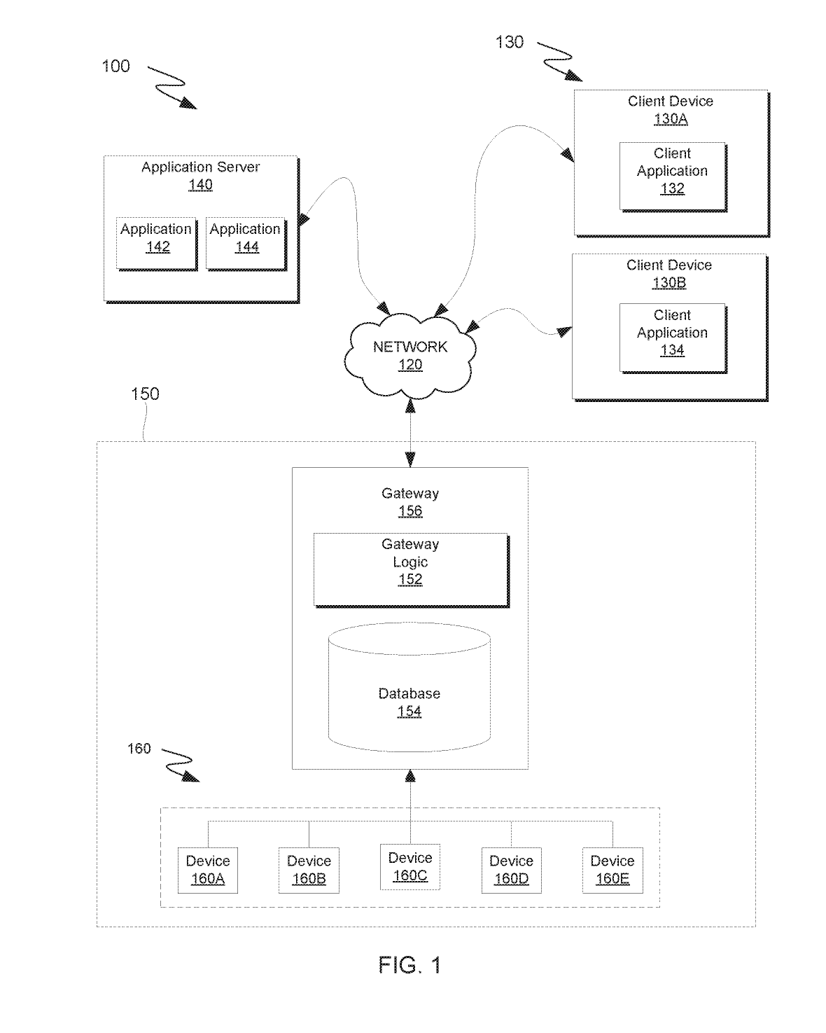

FIG. 1 is a functional block diagram illustrating a computing environment, in accordance with an embodiment of the present invention. For example, FIG. 1 is a functional block diagram illustrating computing environment 100. Computing environment 100 includes application server 140, client devices 130, local IoT environment 150, and network 120. In the embodiment depicted in FIG. 1, network 120 communicatively connects client device 130A and client device 130B (collectively, client devices 130) to application server 140. Network 120 also communicatively connects application server 140 to local IoT environment 150. Additionally, network 120 can communicatively connect client device 130A and client device 130B to local IoT environment 150 in various embodiments of the present invention. In general, network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between the elements described above.

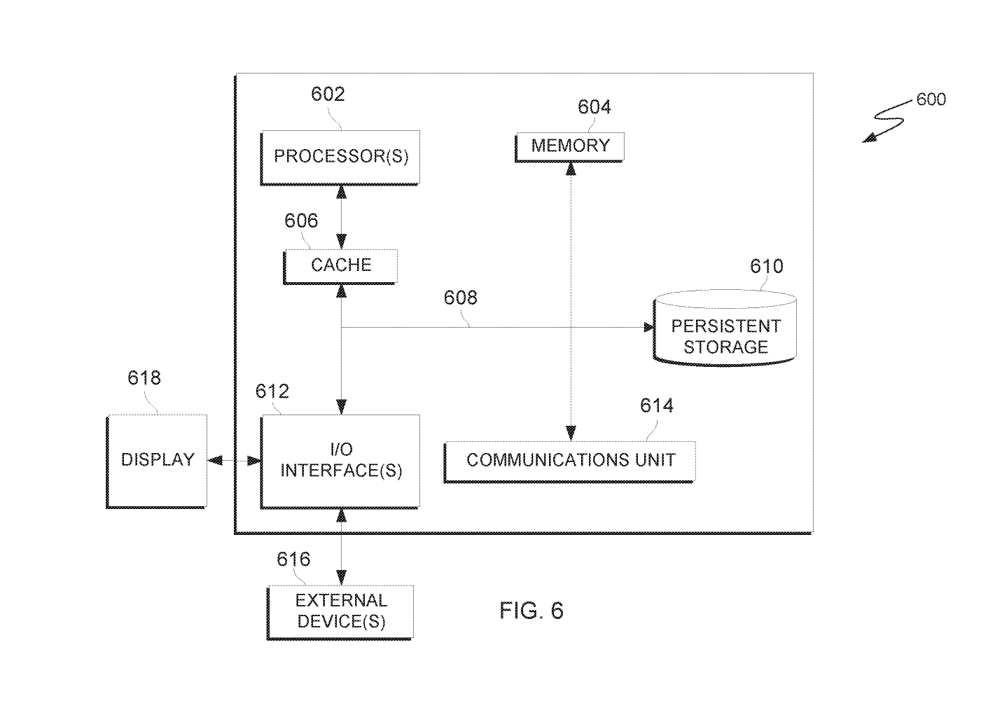

In various embodiments, application server 140 represents a computing device that can be a standalone device, a server, a laptop computer, a tablet computer, a netbook computer, a personal computer (PC), a desktop computer, or any combination or number thereof. In some embodiments, application server 140 represents a computing system utilizing clustered computers and components to act as a single pool of seamless resources. In general, application server 140 can be any computing device or a combination of devices that is communicatively connected to local IoT environment 150 and client devices 130 to provide the functionality described herein. Application server 140 can include internal and external hardware components as described with respect to FIG. 6.

Additionally, in some embodiments, application server 140 represents a cloud computing platform. Cloud computing is a model or service delivery for enabling convenient, on demand network access to a shared pool of configurable computing resources (e.g., networks, network bandwidth, servers, processing, memory, storage, applications, virtual machines, and services) that can be rapidly provisioned and released with minimal management effort or interaction with a provider of a service. A cloud model may include characteristics such as on-demand self-service, broad network access, resource pooling, rapid elasticity, and measured service; can be represented by service models including a platform as a service (PaaS) model, an infrastructure as a service (IaaS) model, and a software as a service (SaaS) model; and can be implemented as various deployment models including as a private cloud, a community cloud, a public cloud, and a hybrid cloud.

In the embodiment depicted in FIG. 1, application 142 and application 144 are respectively stored on and executed by application server 140. In other embodiments, application server 140 can store and/or execute a different count of applications without departing from the scope of the present invention. In general, applications 142 and 144 operate to transmit respective usage-requests to local IoT environment 150, as described herein. Additionally, application 142 and application 144 operate to notify, via network 120, client devices 130 of conditions and/or respective contract events that may occur within local IoT environment 150. Accordingly, application 142 is associated with a first contract event (i.e., a first type of event within local IoT environment 150) and application 144 is associated with a second contract event (i.e., a second type of event within local IoT environment 150) in various embodiments of the present invention. In one example, application 142 takes the form of a well-being monitoring application that utilizes elements of local IoT environment 150 to monitor an individual within a structure and transmits notifications regarding the status of the individual to applicable users of client devices 130 (e.g., notifications that the condition of the individual is nominal and/or that the individual is or is potentially in medical distress), while application 144 takes the form of a home-security application that transmits notifications to applicable users of client devices 130 regarding any security threats within the monitored environment (e.g., fire and/or intrusion by unauthorized individuals). This specific example will be referenced in various embodiments herein to illustrate various aspects of the present inventions, but the present inventions is not to be construed as being limited to such embodiments. In some embodiments, IoT applications executing on application server 140 can also include analytics logic to analyze data from one or more gateways (e.g., gateway 156) to facilitate optimization of device configuration rules, template rules, and other logical operations utilizes by the gateway(s), as described herein.

In various embodiments, each of client device 130A and 130B is a computing device that can be a standalone device, a server, a laptop computer, a tablet computer, a netbook computer, a personal computer (PC), a desktop computer, a wireless mobile device, or any combination thereof. In general, each of client devices 130 can be any computing device or a combination of devices with access to application server 140 and with access to and/or capable of executing respective instances of client applications, such as one or both of client applications 132 and 134. Computing environment 100 can include a different count of client devices 130 without departing from the scope of the present invention. In some embodiments, one or more instances of client applications 132 can be stored externally to client devises of respective users and accessed through a communication network, such as network 120.

In the embodiment depicted in FIG. 1, client application 132 and client application 134 are respectively stored and executed on client device 130A and client device 130B. In general, client application 132 and client application 134 are associated with a respective application executing on application server 140. For example, client application 132 can enable a user of client device 130A to interface with application 142 executing on application server 140 and client application 134 can enable a user of client device 130B to interface with application 144 executing on application server 140 in various embodiments of the present invention. Accordingly, client applications 132 and 134 can provide notifications to respective users with respect to conditions and/or contract events that are respectively associated with application 142 and 144. For example, client application 132 may provide notifications to a relative of the monitored individual in the example described above with respect to the example of application 142 and client application 134 may provide notifications to emergency service(s) with respect to the example of application 144 described above. In some embodiments, multiple client devices of client devices 130 may execute respective instances of client application 132 and/or client application 134. In general, one or more instances of client application 132 and/or client application 134 can reside on other computing device(s), provided that each such instance can access and is accessible by a respective client device of client devices 130, and provided that each such instance can access and is accessible by a respective application executing on application server 140 (e.g., one of applications 142 and 144) or can access local IoT environment 150 directly. Additionally, in embodiments of the present invention in which client application and client devices communicate directly with local IoT environment 150, client application 132 and/or 134, and the respective client device(s) of client devices 130 on which they execute, can represent various aspects of application server 140 and application 142 and/or application 144, respectively, in order to provide the functionality attributed to application 142 and/or application 144.

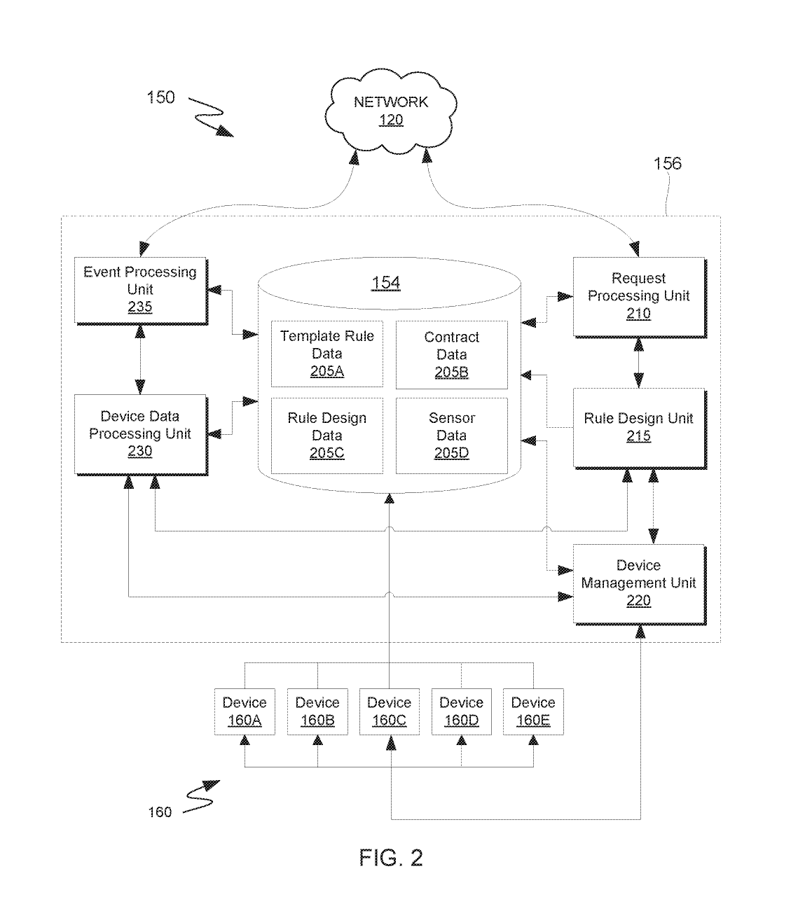

In the embodiment depicted in FIG. 1, local IoT environment 150 includes gateway 156, which is communicatively connected to application server 140 and/or client devices 130 via network 120, and sensory devices 160. Gateway 156 includes gateway logic 152 and database 154, which are described in greater detail with respect to at least FIG. 2. In various embodiments, Gateway 156 represents a computing device that can be a standalone device, a server, a laptop computer, a tablet computer, a netbook computer, a personal computer (PC), a desktop computer, or any combination or number thereof. In some embodiments, for example, gateway 156 is analogous to a router that is provisioned with sufficient processing power, memory, and persistent storage (e.g., network-attached-storage (NAS) drives) to provide the functionality attributed to gateway 156 herein. In some embodiments, it is advantageous to provision gateway 156 with a user interface to facilitate initial configuration and updating of hardware and/or software of gateway 156. The user interface can be provided via a virtual interface (e.g., a graphical user interface accessed via a network communication and another computing device) and/or an interface that is presented via one or more displays and manipulated via one or more user-input devices that are physically connected to, or integrated with, gateway 156. Gateway 156 can include internal and external hardware components as described with respect to FIG. 6.

Sensory devices 160 comprise a plurality of sensors that can be used to detect specified contract event(s). In the embodiment depicted FIGS. 1 and 2, sensory devices 160 comprise device 160A, device 160B, device 160C, device 160D, and device 160E. Sensory devices 160 can include a greater or lesser count of sensory devices without departing from the scope of the present invention. Each sensory device of sensory devices 160 represents one or more sensors with the capability to monitor respective conditions within the local physical environment (i.e., within a respective portion of the monitored environment) and communicate with gateway 156 via a wired and/or wireless connection and an IoT protocol. In some embodiments, multiple sensors of a sensor type are used to provide adequate coverage of the monitored environment for detection of a contract event. In one example, one or more sensory devices of sensory devices 160 is a camera. In another example, one or more sensory devices of sensory devices 160 is a gauge that measures the I/O of utilities (e.g., water, gas, electric utilities). In other embodiments, one or more sensory devices of sensory devices 160 is an audio sensory device or a motion detectors.

To monitor the well-being of an individual within a home, for example, cameras can be placed in various locations within the home to identify the location of the individual at various point in time, furthermore, audio sensory devices can be used to detect certain phrases (e.g., “help,” “I need medical attention,” and “call 911”). In some embodiments, dedicated location tracking devices are affixed to individuals, animals, and objects to be tracked and wirelessly communicate their respective positions to gateway 156. In general, sensory devices 160 operate to transmit data to database 154 so that gateway 156 can determine whether or not a contract event has occurred via gateway logic 152, as described herein. If gateway 156 determines that a contract event has occurred, gateway 156 notifies application server 140 of the contract event so that application server 140 can notify users of client devices 130 (e.g., a relative or caretaker of the monitored individual and/or emergency services). In another example, sensory devices 160 utilize cameras, audio sensors, motion detectors, and/or various other sensors to monitor for intrusion by unauthorized individuals within the monitored environment. If gateway 156 identifies the presence of an unauthorized individual, gateway 156 notifies application server 140 so that application server 140 can notify emergency service(s). One or more IoT sensory devices of sensory devices 160 can include internal and external hardware components as described with respect to FIG. 6.

FIG. 2 is a functional block diagram illustrating a portion of the computing environment depicted in FIG. 1 in greater detail, in accordance with an embodiment of the present invention. More specifically, FIG. 2 depicts local IoT environment 150 in greater detail.

In the embodiment depicted in FIG. 2, gateway 156 is depicted as a collection of logical units that represent respective functions of gateway logic 152. Accordingly, each logical unit represents hardware, which may be dedicated to one logical unit or shared among a plurality of logical units, and program instructions to provide a respective function of gateway logic 152, as described herein. In the embodiment depicted in FIG. 2, the logical units of gateway 156 include request processing unit 210, rule design unit 215, device management unit 220, device data processing unit 230, and event processing unit 235. Gateway 156 also includes database 154, which stores template rule data 205A, contract data 205B, rule design data 205C, and sensor data 205D.

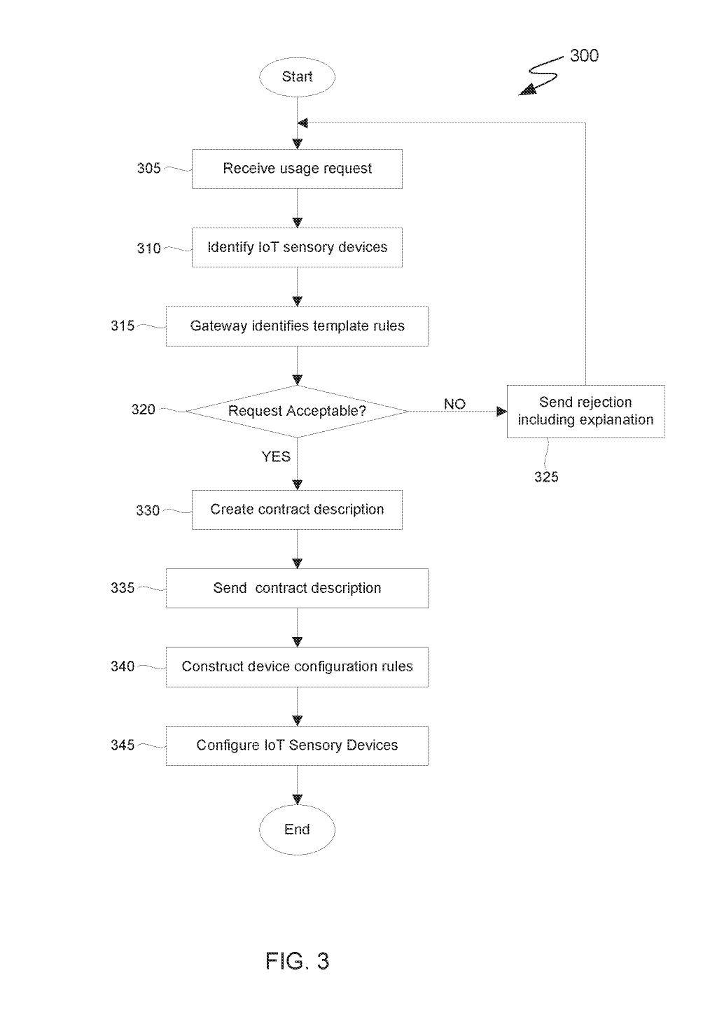

Database 154 is a data repository that may be written to and read by request processing unit 210, rule design unit 215, device management unit 220, device data processing unit 230, and event processing unit 235, as described herein. In general, database 154 represents one or more volatile and/or non-volatile computer memories that gateway logic 152 can read from and write to. In some embodiments, one or more memories represented by database 154 are physically integrated into the structure of gateway 156. In other embodiments, one or more memories represented by database 154 are physically remote from gateway 156 and gateway logic 152 accesses the remote memories via a network such as network 120 or a separate network (e.g., network-attached storage device(s) on a local network within local IoT environment 150). In yet other embodiments, database 154 represents a combination of memories that are physically integrated with gateway 156 and memories that are physically remote from gateway 156. In the embodiment depicted in FIG. 2, database 154 stores template rule data 205A, contract data 205B, rule design data 205C, and sensor data 205D. The various logical units of gateway 156 represented in FIG. 2 read from and write to database 154 as described herein with respect to FIGS. 3, 4, and 5. In some embodiments, database 154 is written to and read by programs and entities outside of local IoT environment 150 in order to populate the repository with data. In some embodiments, for example, application server 140 or entities not depicted in computing environment 100 can pre-populate database 154 with some or all of template rule data 205A, contract data 205B, rule design data 205C, and sensor data 205D.

In the embodiment depicted in FIG. 2, request processing unit 210 can read from and/or write to database 154 and communicates with entities outside of local IoT environment 150 via network 120 and rule design unit 215. Rule design unit 215 can read from and/or write to database 154 and communicates with device management unit 220. Device management unit 220 communicates with sensory devices 160 to configure sensory devices 160. Device management unit 220 can also read from and/or write to database 154 and can communicate with device data processing unit 230. Sensory devices 160 write sensor data 205D to database 154. Device data processing unit can read from and/or write to database 154 and polls database 154 for one or more of template rule data 205A, contract data 205B, rule design data 205C, and sensor data 205D in order to determine whether or not the configuration of sensory devices 160 is optimal at various point in time. Device data processing unit 230 can also communicate with rule design unit 215 and device management unit 220 in order to, among other things, optimize the configuration(s) of sensory devices 160. Device data processing unit 230 can also communicate with event processing unit 235. Event processing unit 235 can read from and/or write to database 154 to determine and record the occurrence of contract events, the nonoccurrence of contract events, and/or conditions within local IoT environment 150. Event processing unit 235 can transmit information regarding contract events and/or conditions within local IoT environment 150 to entities outside of local IoT environment 150 via network 120. Operations of request processing unit 210, rule design unit 215, device management unit 220, device data processing unit 230, and event processing unit 235 are described in more detail with respect to FIGS. 3, 4, and 5.

FIG. 3 is a flowchart depicting operations of the gateway depicted in FIGS. 1 and 2 for configuring a plurality of IoT sensors within a local IoT environment in response to receiving a usage-request from an IoT application, in accordance with an embodiment of the present disclosure. More specifically, FIG. 3 depicts an embodiment of a process for, among other things, receiving a usage-request, determining whether or not the usage-request is feasible, and configuring one or more IoT sensory devices based on the usage-request with respect to the gateway and local IoT environment depicted in FIGS. 1 and 2. Accordingly, operations of gateway logic 152 are described with respect to the logical units of gateway 156 depicted in FIG. 2.

In operation 305, request processing unit 210 of gateway logic 152 receives a usage-request from, for example, application 142 executing on application server 140 over network 120. In general, the usage-request received in operation 305 will describe one or more contract events to detect via sensory devices 160 and any additional parameters and/or requirements relating to detection of the contract event and sending notifications to application server 140. For example, a usage-request from application 142 may specify that gateway 156 is to monitor the well-being of an elderly individual within a home (i.e., within local IoT environment 150). The usage-request may further specify types of sensors to use (e.g., cameras to recognize the individual via facial recognition), notification and/or determination intervals (e.g., make and send a well-being status notification every 60 minutes), conditions for data handling (e.g., delete image data at regular time intervals), conditions for reliability (e.g., 75% reliability), and/or whether or not various parameters are requirements or merely preferences. The usage-request may also enumerate one or more exceptions to various parameters of the usage-request (e.g., to send image data to the requesting IoT application if an unknown person is present and/or to use alternative devices if one or more visual-recognition cameras are not functioning properly or are not present in various portions of the monitored environment).

In operation 310, request processing unit 210 of gateway logic 152 identities each IoT sensory device of sensory devices 160. In the embodiment depicted in FIG. 3, request processing unit 210 queries database 154 to identify each IoT sensory device of sensory devices 160 that is registered in sensor data 205D. Accordingly, in at least some embodiments, device management unit 220 of gateway 156 communicates with sensory devices 160 to maintain a registry of IoT sensory devices within local IoT environment 150. For example, device management unit 220 can, via an IoT protocol, broadcast an instruction for any IoT sensory device that is compatible with the IoT protocol to respond with identifying information such that device management unit 220 can add any new IoT sensory devices within local IoT environment 150 to the registry of IoT sensory devices maintained within database 154 (e.g., sensor data 205D). In another example, one or more IoT sensory devices within local IoT environment 150 broadcast their respective identities in accordance with an IoT protocol to enable device management unit 220 to identify and communicate, in accordance with the IoT protocol, with any such devices. In some embodiments, sensor data 205D is prepopulated with information that identifies and/or describes one or more IoT sensory devices of sensory devices 160 (e.g., in situations in which gateway 156 is provided or sold along with one or more of sensory devices 160 as part of an IoT set designed to detect the contract event(s)).

As described above, sensory devices 160 can comprise one or more types, and one or more instances of each type, of computing and/or sensory devices including cameras, audio sensors, gauges for measuring the I/O of utilities (e.g., water, gas, electricity), smoke detectors, temperature sensors, motion detection sensors, and sensors that can monitor access points (e.g., doorway and/or window sensors), and various other sensors known to persons having ordinary skill in the art. In various embodiments, sensor data 205D includes any combination of: an identifier for each respective IoT sensory device of sensory devices 160; a description of the capabilities of each sensory device; and/or a location of each sensory device (e.g., identifying a specific room and/or orientation of sensor(s)). The description of the capabilities can represent any combination of the type(s) of observation made (e.g., visual, audio, temperature, motion, etc.), a range across which observations can be made (e.g., a field of view, a range of visual wavelengths and/or frequencies, a range of auditory wavelengths and/or frequencies, a temperature range, a range velocities and/or displacements with respect to motion, etc.), sensor sensitivity, and descriptions of various other capabilities of sensory devices 160. In some embodiments, one or more IoT sensory devices of sensory devices 160 provide data that gateway logic 152 uses to service a plurality of usage-requests (e.g., service usage-requests of both application 142 and application 144).

In operation 315, request processing unit 210 of gateway logic 152 queries database 154 for any template rules that are applicable to the received usage-request. In various embodiments, template rule data 205A includes template rules for determining the reliability of one or more sensors (e.g., rules describing how to determine whether or not the IoT sensory devices identified in operation 310 meet a reliability parameter specified by the received usage-request). Template rule data 205A also includes template rules for identifying the one or more contract events described in the received usage-request (e.g., conditions under which observations from each sensor represent the occurrence of a contract event (such as a well-being alert), and/or rules for resolving conflicting observations, such as a rule describing a reliability hierarchy of sensory devices 160). For example, in response to receiving a usage-request relating to the well-being monitory application described herein, the query to database 154 may return a template rule describing conditions for triggering an “alert” via (i) a face-recognition camera (e.g., register an “alert” contract event if a target person remains still for greater than a threshold counts of minutes at various times of day), (ii) an infrared motion sensor (e.g., register a “nominal” contract event activity is detected), and/or (iii) utility monitoring sensors (e.g., register a “nominal” contract event when a faucet is turned on) based, at least in part, on the IoT sensory devices identified in operation 310. Additionally, template rule data 205A can include template rules for optimizing the configuration of sensory devices 160 (e.g., rules describing how to configure sensory devices 160 to meet a reliability parameter of the received usage-request). In general, template rules represent rules and/or guidelines that enable gateway logic 152 to determine whether or not gateway 156 can fulfill the received usage-request within local IoT environment 150, determine whether or not contract event(s) occur within local IoT environment, and/or determine how to optimize the configuration of sensory devices 160 to detect the contract event(s) as conditions change within local IoT environment 150 over time.

In various embodiments, template rule data 205A is populated by entities represented within computing environment 100 of FIG. 1 and/or entities that are not represent within computing environment 100. A single entity can represent various combinations of an IoT sensory device vendor, a gateway vendor, and an IoT application vendor. For example, an IoT sensory device vendor may provide one or more template rules relating to their IoT sensory device(s), a gateway vendor may provide one or more template rules relating to IoT environments for which the gateway is optimized, and/or an IoT application vendor may provide one or more template rules relating to services that the IoT application provides (e.g., detecting the occurrence of contract events). In some embodiments, template rules stored in template rule data 205A are periodically updated based on information obtained from entities outside of local IoT environment 150. For example, application server 140 may periodically query gateway 156 and various other gateways for data representing contract event detection results based on various template rules and corresponding device configuration rules. Application server 140 can execute applications utilizing various machine learning techniques known in the art to identify patterns in contract event detection results with respect to similar contract events (e.g., contract event analytics applications). This information can be used to improve template rules in an effort to improve the reliability and/or accuracy of contract event detection results.

In decision 320, request processing unit 210 determines whether or not gateway 156 meets the requirements of the received usage-request based, at least in part, on the IoT sensory devices identified in operation 310 and the template rules identified in operation 315. If request processing unit 210 determines that gateway 156 can meet the requirements of the received usage-request within local IoT environment 150, (decision 320, YES branch), gateway logic 152 proceeds to operation 330. If request processing unit 210 determines that gateway 156 cannot meet the requirements of the received usage-request within local IoT environment 150, (decision 320, NO branch), request processing unit 210 sends a rejection to the requesting IoT application (e.g., application 142 or 144 executing on application servers 140; operation 325). For example, request processing unit 210 may send a rejection to application 142 if request processing unit 210 determines that it cannot evaluate one or more of the requirements of the received usage-request (e.g., request processing unit 210 cannot determine the reliability of one or more configurations of sensory devices 160) and/or that it cannot meet one or more requirements of the received usage-request (e.g., sensory devices 160 do not include a required type of sensor or provide the required reliability due to too few sensors, the placement of sensors, and/or the capabilities of the various sensors). In some embodiments, the rejection includes an explanation that describes, among other things, the reason(s) for the rejection.

Including an explanation is advantageous in that the explanation may enable the requesting IoT application (e.g., application 142) to provide, to gateway 156, one or more template rules to facilitate analysis and/or servicing of the received usage-request such that request processing unit 210 accepts the request. Additionally, the explanation may enable the requesting IoT application (e.g., application 142) to coach, via a client application, a user of a client device (e.g., a user of client application 132 on client device 130A) as to how to alter the usage-request and/or sensory devices 160 (e.g., identify IoT sensory devices to add to sensory devices 160 and/or how to rearrange sensory deices 160) such that request processing unit 210 can accept the usage-request. Accordingly, gateway logic 152 may receive and identify a subsequent usage-request in another iteration of operation 305 and perform additional iterations of operations 310 and 315 and decision 320. In some embodiments, request processing unit 210 stores information used to determine if an initial “usage-request” is feasible in memory such that the data can be retrieved with less latency in subsequent iterations of operations 305, 310, and 315 and decision 320 with respect to one or more modified usage-requests.

In response to determining that the usage-request is acceptable (decision 320, YES branch), request processing unit 210 creates a “contract description” (operation 330). In some embodiments, the contract description represents an application of the requirement(s) and other parameters(s) of the received usage-request within local IoT environment 150. For example, the contract description can describe the specific observations of sensory devices 160 that cause gateway logic 152 to register the occurrence of the contract event(s) (i.e., the contract description can describe the “detection condition(s)” for the contract event(s)). In some embodiments, the contract description can also describe the values of parameters like reliability and notification intervals that gateway logic 152 determines that gateway 156 can provide based, at least in part, on the information obtained via operations 310 and 315 (i.e., sensors data and template rules). In general, the contract description memorializes the usage-request and is stored in database 154 to enable gateway logic 152 to reference various requirements and/or parameters of the usage-request to, among other things, determine whether or not conditions within local IoT environment 150 correspond with the occurrence of a contract event. In the embodiment depicted in FIG. 2, request processing unit 210 stores the contract description in contract data 205B to enable various logical components of gateway logic 152 (e.g., event processing unit 235) to query database 154 for the contract description and the information contained therein. In the embodiment depicted in FIG. 3, request processing unit 210 also sends the contract description to the requesting IoT application (e.g., application 142 or 144 executing on application server 140; operation 335).

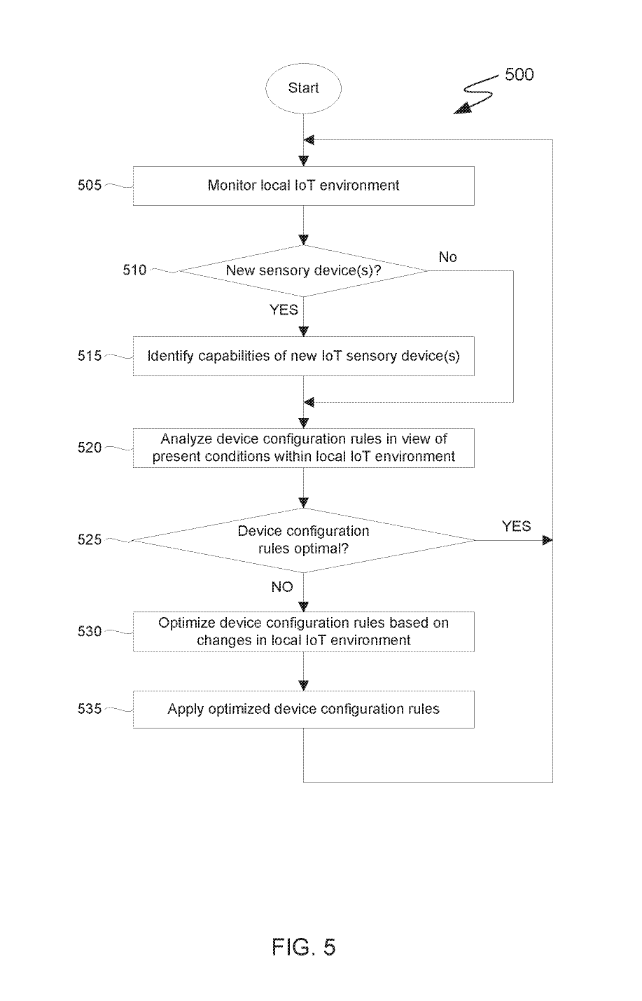

In operation 340, gateway logic 152 constructs a set of “device configuration rules” that describe specific configurations for IoT sensory devices of sensory devices 160 and/or the specific observations (i.e., data) of sensory devices 160 that represent the occurrence or nonoccurrence of the contract event(s) described in the contract description and the received usage-request. In the embodiment depicted in FIG. 2, request processing unit 210 instructs rule design unit 215 to construct the device configuration rules based, in part, on the accepted usage-request. Rule design unit 215 queries database 154 for the contract description representing the accepted usage-request within contract data 205B, any template rules within template rule data 205A that apply to the contract events specified in the contract description, and the identities of any IoT sensory devices of sensory devices 160 that a compatible with the applicable template rules. In general, device configuration rules describe how gateway logic 152 activates and configures IoT sensory devices of sensory devices 160 to detect the contract event(s) and how gateway logic 152 analyzes data from each activated IoT sensory device of sensory devices 160 to detect the contract event(s). In various embodiment, gateway logic 152 includes logic and accesses data to determine how to activate and configure IoT sensory devices based on factors including positioning, orientations, and sensitivities, signal strength in order to optimize reliability, redundancy, accuracy, power efficiency, privacy and security. Rule Design Unit 215 writes the constructed device configuration rules within rule design data 205C of database 154. In the embodiment depicted in FIG. 2, rule design unit 215 notifies device management unit 220 that the constructed device configuration rules are accessible via rule design data 205C and device management unit 220 retrieves the constructed device configuration rules and configures sensory devices 160 in accordance with the constructed device configuration rules (operation 345). As described herein, conditions with respect to sensory devices 160, condition with respect to one or more monitored object and/or individuals, and conditions within local IoT environment 150 may change over time, and therefore, it is advantageous if rule design unit 215 periodically optimizes the device configuration rules in accordance with such changes. Optimizing device configuration rules is discussed in greater detail with respect to FIG. 5.

The example of an IoT application for monitoring the well-being of an individual within a home illustrates some of the elements described above with respect to FIG. 3. In one such example, gateway 156 receives a use-request from such an IoT application (e.g., application 142) that: (i) identifies an individual for monitoring (i.e., a “target” person); (ii) states that facial-recognition camera(s) are a preferred type of IoT sensory device; (iii) identifies a notification interval of one hour; (iv) includes an instruction to discard image data; and (v) includes a first exception stating that the gateway is to send image data to the application (e.g., application 142) when an unknown person is identified within the home and a second exception stating conditions under which usage of alternative IoT sensory devices is permissible (e.g., if facial-recognition cameras are not present and/or available). In response to receiving such a usage-request, gateway logic 152 queries template rule data 205A for template rules relating to well-being monitoring. For example, querying template rule data 205A may yield: (i) a rule for facial-recognition cameras stating that “nominal” contract events are registered when a recognized “target” is moving and that “alert” contract events are registered when the target is motionless for a predetermined amount of time (e.g., ten minutes) during specified hours (e.g., daylight hours); (ii) a rule for infrared motion sensors stating that “nominal” contract events are registered when activity is detected; and (ii) a rule for water-line sensors stating that “nominal” contract events are registered when a water tap is turned on or off.

In this example of a well-being monitoring application, gateway logic 152 queries sensor data 205D, based on the results of the query for template rule data, for IoT sensory devices among devices 160 that can be used to detect the contract events in accordance with the usage-request. In this illustrative example, the query enables gateway logic 152 to identify one or more facial-recognition cameras, one or more infrared motion sensors, one or more water-line sensors, and the location/orientation of each IoT sensory device within the home. Gateway logic 152 generates device configuration rules by, at least in part, applying the template rules relating to well-being monitoring to the identified IoT sensory devices to generate logic that governs, among other things, the IoT sensory devices that gateway logic 152 activates to service the usage-request and the conditions under which gateway 156 notifies the IoT application (e.g., application 142) of the occurrence or nonoccurrence of contract events in accordance with the parameters specified in the usage-request.

The generated device configuration rules cause gateway logic 152 to activate the one or more facial-recognition cameras, one or more infrared motion sensors, and one or more water-line sensors and to configure the activated sensors based on the respective template rules and the usage-request. Additionally, the generated device configuration rules include logic for determining whether to register a “nominal” contract event or an “alert” contract event based on data from the IoT sensory devices. For example, the generated device configuration rules can include a first rule stating that data from the one or more infrared motion sensors and water-line sensors is to be ignored and that gateway logic 152 is to register a “nominal” contract event if the one or more facial-recognition cameras detect movement of the target within a notification interval because the usage-request stipulates that facial-recognition is preferred detection method. Additionally, a second device configuration rule states that if the one or more facial-recognition cameras detect neither a “nominal” contract event nor an “alert contract event,” but the one or more infrared motion sensors or water-line sensors detect a “nominal” contract event within a notification interval, gateway logic 152 registers a “nominal” contract event because use of alternative IoT sensory devices is permissible under the usage-request. In some embodiments, notifications based on contract events that are registered because of data generated by alternative (i.e., non-preferred) IoT sensory devices include language that qualifies the contract event(s) due, for example, to the alternative IoT sensory devices having less reliability and/or accuracy than the preferred IoT sensory devices for detecting the contract event(s). Examples of qualifying language include “probable” and “likely” and similar language. A third device configuration rule states that if neither the one or more facial-recognition cameras nor the one or more infrared motion sensors nor the one or more water-line sensors detect a “nominal” contract event, the gateway registers an “alert” contract event. A fourth device configuration rules states that gateway logic 152 registers an “alert” contract event and notifies the IoT application (e.g., application upon registering the “alert” contact event (i.e., prior to expiration of a notification interval) whenever the one or more facial-recognition cameras detect an “alert” contract event. Persons having ordinary skill in the art will thus understand that the device configuration rules represent a synthesis of information included in the received usage-request (e.g., contract data 205B), template rule data (e.g., template rule data 205A), sensor data (205D), and any additional logic for optimizing IoT sensory devices (e.g., activating and configuring sensory devise 160 within local IoT environment 150) that enable gateway logic 152 determine the appropriate contract event(s) notification to send to one or more IoT applications.

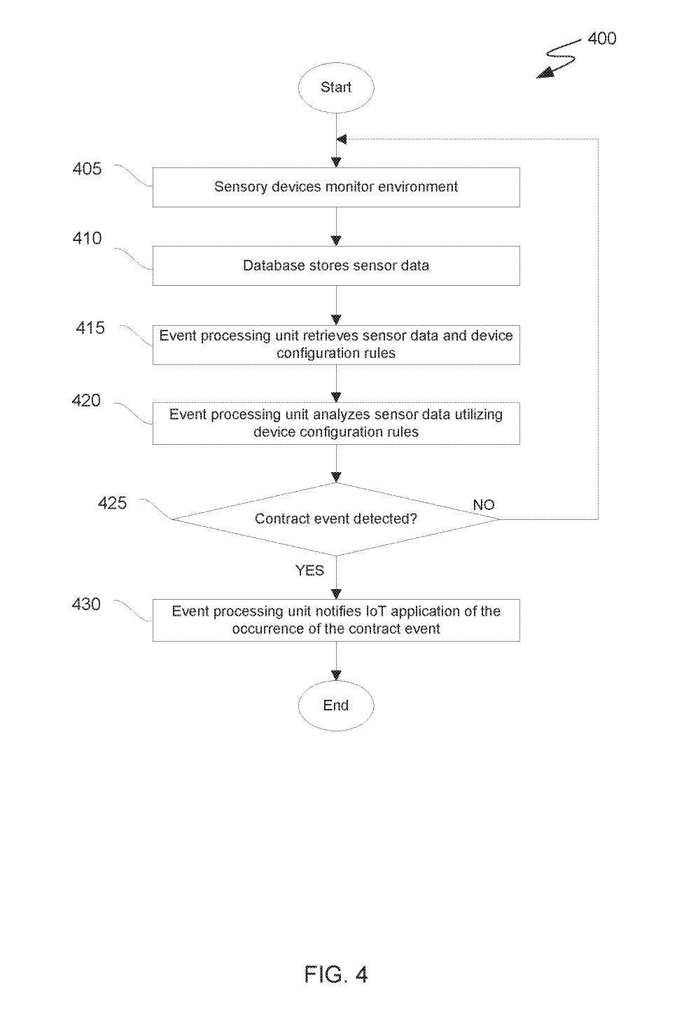

FIG. 4 is a flowchart depicting operations of the gateway depicted in FIGS. 1 and 2 for registering contract events within a local IoT environment in response to receiving a usage-request from an IoT application, in accordance with an embodiment of the present disclosure. More specifically, FIG. 4 is a flowchart depicting operations 400 of gateway logic 152, wherein gateway logic 152 monitors local IoT environment 150, via data generated by sensory devices 160, for contract events specified in one or more received usage-requests.

In operation 405, sensory devices 160 monitor local IoT environment 150 in accordance with device configuration rules generated in response to receiving one or more usage-requests and any modifications made to the device configuration rules. As previously described, sensory devices 160 can include various type of sensors placed in various location within local IoT environment 150. For example, sensory devices 160 can include cameras, audio devices, motion detectors, utility sensors, doorway sensors, window sensors, smoke detector, and various other types of sensors known in the art. Additionally, one or more IoT sensory devices of sensory devices 160 can advantageously service multiple usage-requests at various points in time. For example, an alarm from a smoke detector of sensory devices 160 may cause gateway logic 152 to register an “alert” contract event with respect to a well-being monitoring application (e.g., application 142) and a home-security application (e.g., application 144), thereby potentially and advantageously minimizing a count of IoT sensory devices within local IoT environment 150 compared to providing/configuring dedicated IoT sensory devices for each received usage-request. Accordingly, multiple instances of operations 400, representing respective usage-requests, can execute contemporaneously. In the embodiment depicted in FIG. 2, sensory devices 160 transmit raw sensor data to gateway 156 and database 154 stores and associates the raw sensor data with respective IoT sensory devices in sensor data 205D. In various embodiments, sensor data 205D associates metadata (e.g., timestamps, device locations, device settings, etc.) with the raw sensor data.

As described with respect to FIG. 3 and the exemplary well-being monitoring application (e.g., application 142), in some embodiments, a usage-request may specify a notification interval (i.e., an interval of time) at which gateway 156 is to notify an IoT application of any contract event(s) that have occurred within local IoT environment 150. Additionally, a usage-request may specify a plurality of notification intervals such that one or more of the notification intervals apply to specific types of IoT sensory devices. For example, a first notification interval may apply to all IoT sensory devices among sensory devices 160 and a second, more frequent, notification interval may apply to a subset of one or more types of IoT sensory devices. With respect to the exemplary well-being monitoring application, for example, facial-recognition cameras are a preferred sensor type and are associated with a template rule stating that gateway logic 152 registers “nominal” contract events when a recognized “target” is observed moving and “alert” contract events when the target is motionless for a predetermined amount of time (e.g., ten minutes) during specified hours (e.g., daylight hours). Accordingly, gateway logic 152 may execute an iteration of operations 400 every ten minutes to determine if one or more facial-recognition cameras have detected an “alert” contract event and an iteration of operations 400 every hour to determine whether or not data generated by the one or more facial-recognition cameras and other IoT sensory devices of sensory devices 160 indicate the occurrence of a contract event. Notification intervals can, in some cases, be small enough to represent determinations in substantially real-time (e.g., fractions of a second). For example, gateway logic 152 may monitor data from one or more smoke detectors in substantially real-time in the example of a home-security application (e.g., application 144) to enable notification of emergency services as soon as a fire is detected (i.e., to limit damage to local IoT environment 150 and any individuals within local IoT environment 150).

In other embodiments, gateway 156 may receive requests from an IoT application executing on an application server (e.g., application 142 or 144) and/or a client application executing on a client device (e.g., client application 132 executing on client device 130A) in addition to or in place of requests from an IoT application executing on an application server. Whether gateway logic 152 identifies the expiration of a notification interval or a request for notification from an application server and/or client application, gateway logic 152 periodically analyzes sensor data 205D for contract events. With respect to the embodiment depicted in FIG. 2, event processing unit 235 queries sensor data 205D in database 154 for raw sensor data and/or metadata from which event processing unit 235 can evaluate present conditions within local IoT environment 150 and/or identify any contract events (operation 415). If, for example, a usage-request specifies a notification interval, event processing unit 235 queries sensor data 205D in database 154 for raw sensor data and metadata stored since the expiration of a previous notification interval. Additionally, event processing unit 235 queries rule design data 205C to identify device configuration rules that are relevant to the instant usage-request (i.e., the usage-request associated with the specific instance of operations 400; operation 415).

Event processing unit 235 utilizes the device configuration rules to analyze the data and metadata retrieved from sensor data 205D for contract events specified in instant usage-request (operation 420). If event processing unit 235 determines that the data and/or metadata retrieved from sensor data 205D does not represent any of the contract events specified in the instant usage-request (i.e., that gateway 156 need not send any notification; decision 425, NO branch), gateway logic 152 and local IoT environment 150 continue to monitor for the occurrence of the specific contract events. If event processing unit 235 determines that the data and/or metadata retrieved from sensor data 205D represents one or more of the contract events specified in the instant usage-request (decision 425, YES branch), event processing unit 235 notifies a corresponding IoT application executing on application server 140 (e.g., application 142 or 144) and/or client application depending, at least in part, on how operation 415 was initiated, as described above. Therefore, entities outside of local IoT environment 150 are merely notified of the occurrence of contract events and raw sensor data is advantageously confined to local IoT environment, thereby reducing minimum computer resource requirements (e.g., processor resources, memory, and persistent storage requirements) of such entities/devices, as previously recognized with respect to the present invention. As noted herein, however, specific usage-requests can include exceptions that instruct gateway logic 152 to forward raw sensor data (e.g., image data) under certain specific conditions (e.g., the presence of an unauthorized or unrecognized individual).

Returning again to the example of a well-being monitoring application, operations 400 represent a process for determining whether to register an “alert” contract event or a “nominal” contract event. If event processing unit 235 determines that the data retrieved via operation 415 indicates that the one or more facial-recognition cameras detected movement of the target individual, event processing unit 235 ignores data relating to the one or more infrared motion sensors and water-line sensors and registers a “nominal” contract event due to the first device configuration rule. If, however, the data retrieved via operation 415 indicates that the one or more facial-recognition cameras detected neither a “nominal” contract event nor an “alert” contract event (e.g., because the target individual was not present in an area equipped with facial-recognition camera(s) during the notification interval), but instead that the one or more infrared motion sensors or water-line sensors detected a “nominal” contract event, event processing unit 235 registers a “nominal” contract event due to the second device configuration rule. If, on the other hand, the data retrieved via operation 415 indicates that neither the one or more facial-recognition cameras nor the one or more infrared motion sensors nor the one or more waterline sensors detected a “nominal” contract event, event processing unit 235 registers an “alert” contract event due to the third device configuration rule. In each case, event processing unit 235 subsequently notifies entities outside of local IoT environment 150 of the occurrence of the contract event. If, at any point, however, the data retrieved via operation 415 indicates that the one or more facial-recognition cameras detected an “alert” contract event (i.e., the target is motionless for a specified amount of time), event processing unit 235 registers an “alert” contract event due to the fourth device configuration rule. Accordingly, some iterations of operations 400 are specific to evaluating data generated by the one or more facial-recognition cameras during the notification interval that is specific to the facial-recognition camera(s) (i.e., the period of time specified by the fourth device configuration rule or an even shorter period of time), as previously described.

FIG. 5 is a flowchart depicting operations of the gateway depicted in FIGS. 1 and 2 for optimizing IoT sensory device configuration rules, in accordance with an embodiment of the present disclosure. More specifically FIG. 5 is a flowchart depicting operations 500 of gateway logic 152, wherein gateway logic 152 monitors local IoT environment 150 for various changes within local IoT environment 150 and optimizes the device configuration rules based on the changes.

Embodiments of the present invention recognize that changes can occur within local IoT environment 150 over time. These changes can include the addition of new IoT sensory devices and/or new types of IoT sensory devices, the removal of IoT sensory devices and/or types of IoT sensory devices, changes with respect to environmental conditions (e.g., time of day, weather, etc.), and changes with respect to monitored objects and/or individuals (e.g., the location of an individual, when an individual is sleeping, etc.). Accordingly, gateway logic 152 monitors local IoT environment 150 for such changes. In operation 505, device data processing unit 230 of gateway 156 monitors local IoT environment 150 by, at least in part, querying database 154 for sensor data 205D and/or querying device management unit 220 for changes to sensory devices 160. In various embodiments, one or more IoT sensory devices of sensory devices 160 can be incapable of detecting contract events, but gateway logic 152 utilizes such IoT sensory devices to record, in sensor data 205D, data describing conditions with respect to environmental conditions and/or monitored objects/individuals within local IoT environment 150; device data processing unit 230 can query database 154 for this data in operation 505. As previously described, device management unit 220 can also communicate with sensory devices 160 in accordance with various IoT protocols to, among other things, maintain a registry of IoT sensory devices within local IoT environment 150. In some embodiments, operation 505 represents, at least in part, an operation in which device data processing unit 230 queries device management unit 220 to identify the IoT sensory devices presently within local IoT environment 150. In addition to or in place of querying device management unit 220, device data processing unit 230 can query database 154 for the registry of IoT sensory devices in sensor data 205D directly in some embodiments of the invention.

If device data processing unit 230 determines that new IoT sensory devices are present within local IoT environment 150 (decision 510, YES branch), device data processing unit 230 identifies the capabilities of each new IoT sensory device (operation 515) via any identifying and/or descriptive information contained within the registry of IoT sensory devices in sensor data 205D and/or any template rules contained within template rule data 205A for respective types of IoT sensory devices. Based on the identified capabilities of the new IoT sensory devices, any template rules that correspond to the new IoT sensory devices, and any other changes to local IoT environment 150 observed in operation 505, device data processing unit 230 analyzes the presently applied set of device configuration rules (operation 520) to determine whether or not the set of device configuration rules are optimal (decision 525). If device data processing unit 230 determines that no new IoT sensory devices are present within local IoT environment 150 (decision 510, NO branch), device data processing unit 230 analyzes the presently applied set of device configuration rules based on the conditions within local IoT environment 150 observed in operation 505 (operation 520) to determine whether or not the device configuration rules are optimal (decision 525). If device data processing unit 230 determines that the presently applied set of device configuration rules is optimal (decision 525, YES branch), gateway logic 152 executes a subsequent iteration of operations 500 (i.e., device data processing unit 230 monitors local IoT environment for any changes). For example, a presently applied set of device configuration rules can be optimal for an instant usage-request in spite of a new type of IoT sensory device appearing within local IoT environment 150 if no template rule(s) exist for the new type IoT sensory device with respect to the contract events of the instant usage-request/contract description. In some embodiments, determining that the presently applied set of device configuration rules is not optimal (decision 525, NO branch) can also represent a determination that new template rules exist in template rule data 205A for IoT sensory devices previously identified within local IoT environment 150. Gateway logic 152 can be provisioned such that gateway logic 152 determines whether or not the presently applied device configuration rules are optimal at regular intervals.

If device data processing unit 230 determines that the presently applied set of device configuration rules is not optimal (decision 525, NO branch), device data processing unit 230 instructs rule design unit 215 to construct a new set of device configuration rules reflecting one or any combination of factors including (i) the addition of new IoT sensory devices and/or new types of IoT sensory devices, (ii) the removal of IoT sensory devices and/or types of IoT sensory devices, (iii) changes with respect to environmental conditions, (iv) changes with respect to monitored objects and/or individuals, as identified in operation 505, and (v) any newly available and/or updated template rules (e.g., new template rules provided by applications 142 or 144 based on analyses of the reliability and/or accuracy of previous contract even determinations). In some embodiments, a determination that the presently applied set of device configuration rules is not optimal represents a determination that the reliability and/or accuracy of registering contract events can be increased by modifying the presently applied set of device configuration rules based on the changes within local IoT environment 150 and/or newly available template rule, thereby advantageously improving the performance of gateway 156 within local IoT environment 150. In accordance with the embodiment depicted in FIG. 2, rule design unit 215 stores the updated, optimized set of device configuration rules in rule design data 205C and instructs device management unit 220 to configure sensory devices 160 in accordance with the updated and optimized set of device configuration rules.

Additionally, in some embodiments, multiple sets of device configuration rules are stored in rule design data 205C. In such embodiments, determining that the presently applied set of device configuration rules is not optimal (decision 525, NO branch) and optimizing the device configuration rules based on changes in local IoT environment (operation 530) represent determining that event processing unit 235 should utilize a different set of device configuration rules to register the occurrence or nonoccurrence of contract events based on the present conditions within local IoT environment 150 and instructing event processing unit 235 to utilize the appropriate set of device configuration rules (operation 535). If, for example, gateway logic 152 identifies a new type of IoT sensory device among sensory devices 160, gateway logic 152 can dynamically construct and implement an alternative set of device configuration rules to advantageously optimize the design configuration rules by taking advantage of the capabilities of the newly identified type of IoT sensory device (e.g., a mobile IoT sensory device). If gateway logic 152 determines that the newly identified IoT sensory device is no longer present within local IoT environment 150, gateway logic 152 can revert back to the previous set of device configuration rules absent any additional changes within local IoT environment 150 that have an effect on the optimal set of device configuration rules. Similarly, gateway logic 152 can dynamically optimize the device configuration rules by detecting IoT sensory devices that go into failure states and modifying the device configuration rules accordingly.

Returning yet again to the example of a well-being monitoring application (e.g., application 142), this exemplary embodiment illustrates various elements discussed with respect to FIG. 5. In operation 505, for example, device data processing unit 230 may monitor conditions within the home (operation 505) and detect a new portable electronic device (e.g., a smartphone, tablet, smart watch, etc.) that is configured as an IoT sensory device (e.g., executing an application or firmware that includes instructions for wirelessly communicating with gateway 156 via the IoT protocol) and includes one or more sensors (e.g., global positioning system (GPS) antennae, accelerometer(s), gyroscope(s), camera(s), microphone(s), etc.). If device data processing unit 230 determines that one or more template rules in template rule data 205A are applicable to the sensor(s) of the newly identified portable electronic device, device data processing unit 230 instructs rule design unit 215 to dynamically construct a new set of device configuration rules to take advantage of the newly identified portable electronic device and instructs device management unit 220 to apply the new set of device configuration rules to the newly identified portable electronic device and other IoT sensory devices of sensory devices 160, as applicable. Similarly, device data processing unit 230 instructs event processing unit 235 to utilize the new set of device configuration rules to register contract events.

More specifically, the new set of device configuration rules may utilize accelerometer(s) and/or gyroscope(s) of the portable electronic device to register “nominal” contract events based on a template rule stating that movement of the portable electronic device can represent an inference of the target individual's movement. If device data processing unit 230 determines that motion-detecting sensors of the portable electronic device are more reliable for detecting contract events than the one or more infrared motion sensors and/or water-line sensors (e.g., via a template rule or based on an analysis of sensor data 205D or other data), rule design unit 215 advantageously improves the reliability of gateway logic 152 by constructing device configuration rule(s) that ignore data from the one or more infrared motion sensors and/or water-line sensors when the portable electronic device detects movement of itself. If, for example, device data processing unit 230 determines that the target individual is at the location of a facial-recognition camera, the device configuration rules instruct event processing unit 235 to ignore data from all other IoT sensory devices because the usage-request/contract description states that facial-recognition cameras are a preferred type of sensory device. If, however, device data processing unit 230 determines that the target individual is not at a location of a facial-recognition camera, the device configuration rules instruct event processing unit 235 to utilize data from the one or more infrared motion sensors and/or water-line sensors unless the portable electronic device is present within the home (i.e., ignore data for the one or more infrared motion sensors and/or water-line sensors if conflicting data from the portable electronic device is available). In some embodiments, device management unit 220 periodically communicates with the portable electronic devices to obtain the position of the portable electronic devices (e.g., via GPS, radiofrequency beacons, etc.) at regular intervals and/or each time the portable electronic devices are moved about the home to enable device data processing unit 230 to infer the position of the target individual based on the location of the portable electronic device.

In some cases, the portable electronic device itself may include sensors that duplicate, at least in part, the capabilities of one or more other IoT sensory devices of sensory devices 160 (e.g., a facial-recognition camera, a finger-print scanner, or another form of identity verification.). In such cases, device data processing unit 230 may determine that it is advantageous to further optimize the device configuration rules by instructing device management unit 220 to deactivate one or more IoT sensory devices of sensory devices 160 that duplicate respective capabilities of the portable electronic device while the portable electronic device is present within local IoT environment 150 (e.g., the home). Deactivating one or more IoT sensory devices may be advantageous in order to reduce energy consumption within local IoT environment 150, reduce the amount of data stored in database 154 (i.e., reducing the minimum amount of data storage required), and/or reduce the amount of data that event processing unit 235 must analyze to register contract events (i.e., reduce the resource requirements and time for contract-event registration).

FIG. 6 is a block diagram of components of a computing device, generally designated 600, in accordance with an embodiment of the present invention. In one embodiment, computing system 600 is representative of one or more of application server 140, client device 130A, client device 130B, gateway 156, and/or one or more IoT sensory devices of sensory devices 160 executing any logic attributed thereto.

It should be appreciated that FIG. 6 provides only an illustration of one implementation and does not imply any limitations with regard to the environments in which different embodiments may be implemented. Many modifications to the depicted environment may be made.

Computing system 600 includes processor(s) 602, cache 606, memory 604, persistent storage 610, input/output (I/O) interface(s) 612, communications unit 614, and communications fabric 608. Communications fabric 408 provides communications between cache 606, memory 604, persistent storage 610, communications unit 614, and input/output (I/O) interface(s) 612. Communications fabric 608 can be implemented with any architecture designed for passing data and/or control information between processors (such as microprocessors, communications and network processors, etc.), system memory, peripheral devices, and any other hardware components within a system. For example, communications fabric 408 can be implemented with one or more buses or a crossbar switch.

Memory 604 and persistent storage 610 are computer readable storage media. In this embodiment, memory 604 includes random access memory (RAM). In general, memory 604 can include any suitable volatile or non-volatile computer readable storage media. Cache 606 is a fast memory that enhances the performance of processor(s) 602 by holding recently accessed data, and data near recently accessed data, from memory 604.

Program instructions and data used to practice embodiments of the present invention may be stored in persistent storage 610 and in memory 604 for execution by one or more of the respective processor(s) 602 via cache 606. In an embodiment, persistent storage 610 includes a magnetic hard disk drive. Alternatively, or in addition to a magnetic hard disk drive, persistent storage 610 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 610 may also be removable. For example, a removable hard drive may be used for persistent storage 610. Other examples include optical and magnetic disks, thumb drives, and smart cards that are inserted into a drive for transfer onto another computer readable storage medium that is also part of persistent storage 610.

Communications unit 614, in these examples, provides for communications with other data processing systems or devices. In these examples, communications unit 614 includes one or more network interface cards. Communications unit 614 may provide communications through the use of either or both physical and wireless communications links. Program instructions and data used to practice embodiments of the present invention may be downloaded to persistent storage 610 through communications unit 614.

I/O interface(s) 612 allows for input and output of data with other devices that may be connected to computer system 600. For example, I/O interface(s) 612 may provide a connection to external device(s) 616 such as a keyboard, keypad, a touch screen, and/or some other suitable input device. External device(s) 616 can also include portable computer readable storage media such as, for example, thumb drives, portable optical or magnetic disks, and memory cards. Software and data used to practice embodiments of the present invention can be stored on such portable computer readable storage media and can be loaded onto persistent storage 610 via I/O interface(s) 612. I/O interface(s) 612 also connect to display 618.

Display 618 provides a mechanism to display or present data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, a list of alternatives such as “at least one of A, B, and C” should be interpreted to mean “at least one A, at least one B, at least one C, or any combination of A, B, and C.”

Additionally, the phrase “based on” should be interpreted to mean “based, at least in part, on.”

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for managing internet of things (IoT) device configuration rules, the method comprising:
identifying, via a gateway node within an IoT network, a usage-request that describes one or more contract events;
identifying, via the gateway node, a plurality of IoT sensory devices within a local IoT environment in response to querying a database for IoT sensory devices within the local IoT environment;
identifying, via the gateway node, a plurality of template rules in response to querying the database for template rules that describe conditions for registering occurrences of the one or more contract events, wherein each template rule represents a rule for a type of IoT sensory device;
identifying, via the gateway node, a subset of template rules from among the plurality of template rules that correspond to types of IoT sensory devices represented by a subset of IoT sensory device of the plurality of IoT sensory devices within the local IoT environment;
constructing, via the gateway node, a set of device configuration rules based, at least in part, on the subset of template rules and the subset of IoT sensory devices within the local IoT environment, wherein the set of device configuration rules describes logical operations for registering occurrences the one or more contract events described in the usage-request via the subset of IoT sensory devices within the local IoT environment; and
configuring, via the gateway node, the subset of IoT sensory devices in accordance with the set of device configuration rules.

2. The method of claim 1, further comprising:
identifying, via the gateway node, data generated by the subset of IoT sensory devices in response to querying the database for data generated by the subset of IoT sensory devices during a notification interval;
determining, via the gateway node, that the data generated by the subset of IoT sensory devices indicates that a contract event occurred during the notification interval in response to analyzing the data generated by the subset of IoT sensory devices in accordance with the set of device configuration rules; and
sending to an IoT application executing on a separate node in the IoT network, via the gateway node, a notification that describes the contract event that occurred during the notification interval, wherein the notification does not include the data generated by the subset of IoT sensory devices.

3. The method of claim 1, further comprising:
identifying, via the gateway node, a new IoT sensory device within the local IoT environment that represents a new type of IoT sensory device that was not previously present within the local IoT environment;
identifying, via the gateway node, a new template rule that describes conditions for detecting the one or more contract events of the usage-request in response to querying the database for template rules that correspond to the new type of IoT sensory device;
constructing, via the gateway node, an optimized set of device configuration rules based, at least in part, on the new template rule, the subset of template rules, the new IoT sensory deice, and the subset of IoT sensory devices within the local IoT environment; and
configuring, via the gateway node, the new IoT sensory device and the subset of IoT sensory devices in accordance with the optimized set of device configuration rules.

4. The method of claim 3, further comprising:
determining, via the gateway node, that incorporating the new template rule into the set of device configuration rule increases accuracy with respect to registering occurrences of contract events, and in response, constructing the optimized set of device configuration rules.

5. The method of claim 3, wherein the new IoT sensory device is a portable electronic device that wirelessly communicates with the gateway node via an IoT protocol.

6. The method of claim 5, further comprising:
determining, via the gateway node, that the new IoT sensory device is no longer within the local IoT environment, and in response, optimizing the device configuration rules by reverting to the set of device configuration rules based on the subset of template rules and the subset of IoT sensory devices within the local IoT environment.

7. The method of claim 1, further comprising:
identifying, via the gateway node, a new template rule that describes conditions for detecting one of the one or more contract events of the usage-request, wherein the new template is based, at least in part, on analyses of contract event determinations made by a plurality of gateway nodes;
constructing, via the gateway node, an optimized set of device configuration rules based, at least in part, on the new template rule, the subset of template rules, and the subset of IoT sensory devices within the local IoT environment; and
configuring, via the gateway node, the subset of IoT sensory devices in accordance with the optimized set of device configuration rules.

8. A computer program product for managing internet of things (IoT) device configuration rules, the computer program product comprising:
a computer readable storage medium and program instructions stored on the computer readable storage medium, the program instructions comprising:
program instructions to identify, via a gateway node within an IoT network, a usage-request that describes one or more contract events;
program instructions to identify, via the gateway node, a plurality of IoT sensory devices within a local IoT environment in response to querying a database for IoT sensory devices within the local IoT environment;
program instructions to identify, via the gateway node, a plurality of template rules in response to querying the database for template rules that describe conditions for registering occurrences of the one or more contract events, wherein each template rule represents a rule for a type of IoT sensory device;
program instructions to identify, via the gateway node, a subset of template rules from among the plurality of template rules that correspond to types of IoT sensory devices represented by a subset of IoT sensory device of the plurality of IoT sensory devices within the local IoT environment;
program instructions to construct, via the gateway node, a set of device configuration rules based, at least in part, on the subset of template rules and the subset of IoT sensory devices within the local IoT environment, wherein the set of device configuration rules describes logical operations for registering occurrences the one or more contract events described in the usage-request via the subset of IoT sensory devices within the local IoT environment; and
program instructions to configure, via the gateway node, the subset of IoT sensory devices in accordance with the set of device configuration rules.

9. The computer program product of claim 8, the computer instructions further comprising: further comprising:
program instructions to identify, via the gateway node, data generated by the subset of IoT sensory devices in response to querying the database for data generated by the subset of IoT sensory devices during a notification interval;
program instructions to determine, via the gateway node, that the data generated by the subset of IoT sensory devices indicates that a contract event occurred during the notification interval in response to analyzing the data generated by the subset of IoT sensory devices in accordance with the set of device configuration rules; and
program instructions to send to an IoT application executing on a separate node in the IoT network, via the gateway node, a notification that describes the contract event that occurred during the notification interval, wherein the notification does not include the data generated by the subset of IoT sensory devices.

10. The computer program product of claim 8, further comprising:
program instructions to identify, via the gateway node, a new IoT sensory device within the local IoT environment that represents a new type of IoT sensory device that was not previously present within the local IoT environment;
program instructions to identify, via the gateway node, a new template rule that describes conditions for detecting the one or more contract events of the usage-request in response to querying the database for template rules that correspond to the new type of IoT sensory device;
program instructions to construct, via the gateway node, an optimized set of device configuration rules based, at least in part, on the new template rule, the subset of template rules, the new IoT sensory deice, and the subset of IoT sensory devices within the local IoT environment; and
program instructions to configure, via the gateway node, the new IoT sensory device and the subset of IoT sensory devices in accordance with the optimized set of device configuration rules.

11. The computer program product of claim 10, the program instructions further comprising:
program instructions to determine, via the gateway node, that incorporating the new template rule into the set of device configuration rule increases accuracy with respect to registering occurrences of contract events, and in response, construct the optimized set of device configuration rules.

12. The computer program product of claim 10, wherein the new IoT sensory device is a portable electronic device that wirelessly communicates with the gateway node via an IoT protocol.

13. The computer program product of claim 12, the program instructions further comprising:
program instructions to determine, via the gateway node, that the new IoT sensory device is no longer within the local IoT environment, and in response, optimize the device configuration rules by reverting to the set of device configuration rules based on the subset of template rules and the subset of IoT sensory devices within the local IoT environment.

14. The computer program product of claim 8, the program instructions further comprising:
program instructions to identify, via the gateway node, a new template rule that describes conditions for detecting one of the one or more contract events of the usage-request, wherein the new template is based, at least in part, on analyses of contract event determinations made by a plurality of gateway nodes;
program instructions to construct, via the gateway node, an optimized set of device configuration rules based, at least in part, on the new template rule, the subset of template rules, and the subset of IoT sensory devices within the local IoT environment; and
program instructions to configure, via the gateway node, the subset of IoT sensory devices in accordance with the optimized set of device configuration rules.

15. A computer system for managing internet of things (IoT) device configuration rules, the computer system comprising:
one or more computer processors;
one or more computer readable storage media;
program instructions stored on the one or more computer readable storage media for execution by at least one of the one or more processors, the program instructions comprising:
program instructions to identify, via a gateway node within an IoT network, a usage-request that describes one or more contract events;
program instructions to identify, via the gateway node, a plurality of IoT sensory devices within a local IoT environment in response to querying a database for IoT sensory devices within the local IoT environment;
program instructions to identify, via the gateway node, a plurality of template rules in response to querying the database for template rules that describe conditions for registering occurrences of the one or more contract events, wherein each template rule represents a rule for a type of IoT sensory device;
program instructions to identify, via the gateway node, a subset of template rules from among the plurality of template rules that correspond to types of IoT sensory devices represented by a subset of IoT sensory device of the plurality of IoT sensory devices within the local IoT environment;
program instructions to construct, via the gateway node, a set of device configuration rules based, at least in part, on the subset of template rules and the subset of IoT sensory devices within the local IoT environment, wherein the set of device configuration rules describes logical operations for registering occurrences the one or more contract events described in the usage-request via the subset of IoT sensory devices within the local IoT environment; and
program instructions to configure, via the gateway node, the subset of IoT sensory devices in accordance with the set of device configuration rules.

16. The computer system of claim 15, the computer instructions further comprising: further comprising:
program instructions to identify, via the gateway node, data generated by the subset of IoT sensory devices in response to querying the database for data generated by the subset of IoT sensory devices during a notification interval;
program instructions to determine, via the gateway node, that the data generated by the subset of IoT sensory devices indicates that a contract event occurred during the notification interval in response to analyzing the data generated by the subset of IoT sensory devices in accordance with the set of device configuration rules; and
program instructions to send to an IoT application executing on a separate node in the IoT network, via the gateway node, a notification that describes the contract event that occurred during the notification interval, wherein the notification does not include the data generated by the subset of IoT sensory devices.

17. The computer system of claim 15, further comprising:
program instructions to identify, via the gateway node, a new IoT sensory device within the local IoT environment that represents a new type of IoT sensory device that was not previously present within the local IoT environment;
program instructions to identify, via the gateway node, a new template rule that describes conditions for detecting the one or more contract events of the usage-request in response to querying the database for template rules that correspond to the new type of IoT sensory device;
program instructions to construct, via the gateway node, an optimized set of device configuration rules based, at least in part, on the new template rule, the subset of template rules, the new IoT sensory deice, and the subset of IoT sensory devices within the local IoT environment; and
program instructions to configure, via the gateway node, the new IoT sensory device and the subset of IoT sensory devices in accordance with the optimized set of device configuration rules.

18. The computer system of claim 17, the program instructions further comprising:
program instructions to determine, via the gateway node, that incorporating the new template rule into the set of device configuration rule increases accuracy with respect to registering occurrences of contract events, and in response, construct the optimized set of device configuration rules.

19. The computer system of claim 17, the program instructions further comprising:
program instructions to determine, via the gateway node, that the new IoT sensory device is no longer within the local IoT environment, and in response, optimize the device configuration rules by reverting to the set of device configuration rules based on the subset of template rules and the subset of IoT sensory devices within the local IoT environment, wherein the new IoT sensory device is a portable electronic device that wirelessly communicates with the gateway node via an IoT protocol.

20. The computer system of claim 15, the program instructions further comprising:
program instructions to identify, via the gateway node, a new template rule that describes conditions for detecting one of the one or more contract events of the usage-request, wherein the new template is based, at least in part, on analyses of contract event determinations made by a plurality of gateway nodes;
program instructions to construct, via the gateway node, an optimized set of device configuration rules based, at least in part, on the new template rule, the subset of template rules, and the subset of IoT sensory devices within the local IoT environment; and
program instructions to configure, via the gateway node, the subset of IoT sensory devices in accordance with the optimized set of device configuration rules.
